(19) United States
(12) Patent Application Publication
(10) Pub. No.: US 2014/0190071 A1
(43) Pub. Date: Jul. 10, 2014

(54) String Bug Light Termination System

(71) Applicant: Loretta Mistretta, E. Patchogue, NY (US)

(72) Inventor: Loretta Mistretta, E. Patchogue, NY (US)

(21) Appl. No.: 13/738,291

(22) Filed: Jan. 10, 2013

(51) Int. Cl. A01M 1/22; A01M 1/04

(52) U.S. Cl. CPC A01M 1/223; A01M 1/04
USPC 43/112; 43/113

(57) ABSTRACT

A string bug light termination system including: a lighting means, an electrocution means, and a connecting means; the connecting means for connecting the lighting means, and electrocution means to a power source in parallel; the lighting means including: a plurality of light assemblies connected together in series by a plurality of conductive wires; and the electrocution circuit means including: a voltage multiplying means including a voltage multiplier circuit connected in series with a plurality of conductive wires; the conductive wires connecting a plurality of inner mesh means in series; and the conductive wires connecting a plurality of outer mesh means in series.

### BACKGROUND OF THE INVENTION

This invention relates to a bug light termination system, in particular, a string bug light termination system that provides, inter alia, a system which attracts bugs to light, and there after terminates their life, while providing an array of light devices connected together.

Historically, many of us have experienced the annoying and unsanitary presence of insects during a picnic, whether out in one's backyard, a neighbor's barbeque, the beach, or other outdoor activity where there is a trash receptacle, or disposed food items. There exists an array of products on the market to reduced, and/or eradicate these pests, aka bugs in the dining/party zone, however, none address the issue as to blending into the décor, and providing ambiance to the dining/party zone, hence, there is a need for a product that improves the sanitary conditions, and the ambiance via visual contributions, by reducing the occupancy of insects in the zone in question.

### SUMMARY OF THE INVENTION

The present invention is directed to a string bug light termination system having a lighting means, an electrocution means, and a connecting means; said connecting means for connecting said lighting means, and electrocution means system to a power source in parallel; said lighting means comprising: a plurality of light assemblies connected together in series by a plurality of conductive wires (black/white/ground); and said electrocution circuit means, comprising: a voltage multiplying means comprising a voltage multiplier circuit connected in series with a plurality of conductive wires (black/white/ground); said conductive wires (red) connecting a plurality of inner mesh means in series; and said conductive wires (black) connecting a plurality of outer mesh means in series.

An objective of the present invention is to reduce the population of the bugs in the deployed area.

Another objective of the present invention includes improving the sanitary conditions of the deployed area.

A further objective of the present invention includes improving the ambiance of the deployed area by providing a lighting system having population control of bugs.

A still further objective of the present invention includes providing an aesthetically pleasing device that controls the bug population whilst providing a simple installation of the system.

Other objectives, advantages, and novel features of the present invention will become more apparent from the following detailed description when taken in conjunction with the accompanying drawings.

### BRIEF DESCRIPTION OF THE DRAWINGS

The following drawings, in which like reference characters indicate like parts, are provided for illustration of the invention and are not intended to limit the invention in any manner whatsoever.

FIG. 1 illustrates a voltage multiplier means of the preferred embodiment of the present invention;

FIG. 2 illustrates a lighting means and electrocution means of the preferred embodiment of the present invention;

FIG. 3 illustrates a block diagram of the preferred embodiment of the present invention;

FIG. 4 illustrates a lighting means of an alternative embodiment of the present invention, wherein each light assembly has a voltage multiplier circuit dedicated thereto; and

FIG. 5 illustrates a block diagram of an alternative embodiment of the present invention.

### DETAILED DESCRIPTION OF THE INVENTION

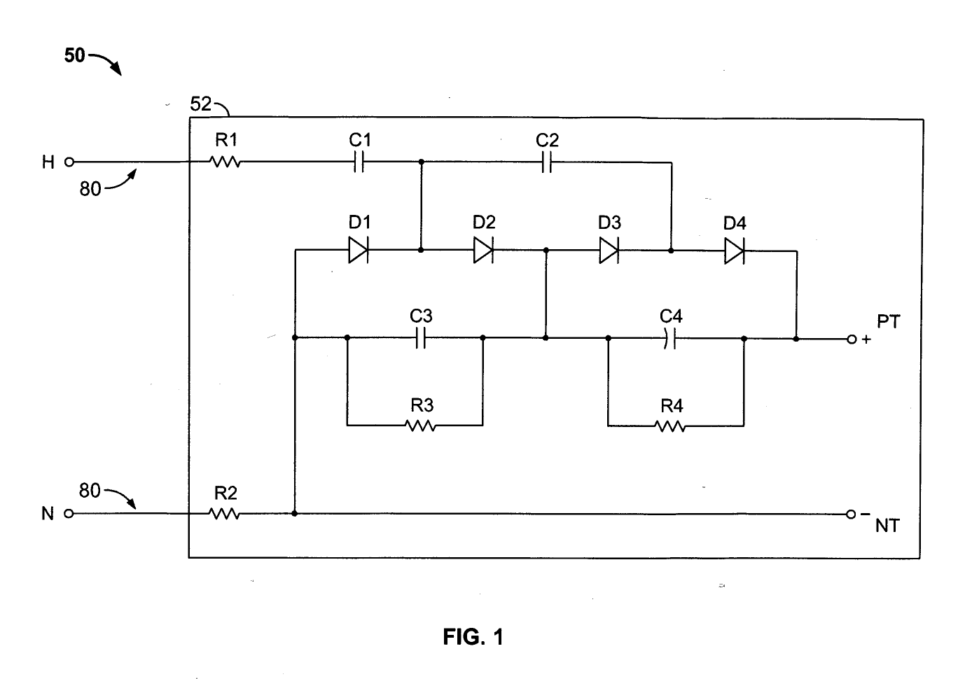

The following descriptions of the preferred embodiments are presented to illustrate the present invention and are not to be construed to limit the claims in any manner whatsoever. In reference to the drawings, namely FIGS. 1 through 5, the preferred embodiment of the present invention is disclosed, which is directed to a string bug light termination system.

The string bug light termination system 1 comprises a lighting means 10, an electrocution means 50, and a connecting means 80; wherein said connecting means 80 for connecting said lighting means 10, and electrocution means 50 to a power source in parallel.

The lighting means 10 comprises a plurality of light assemblies 12, connected together in series by a plurality of conductive wires 14A, 14B (black/white/ground). Each light assembly 12 includes a light 16, and a base 18 for receiving said light 16, for providing means to connect to the conductive wires 14A, 14B, and providing means for the inner and outer mesh means 54, 64 to connect to the conductive wires 52A, 52B, wherein said light 16 is selected from the group consisting of: a light emitting diode, an incandescent bulb, and a fluorescent bulb, and is shown as a LED. It should be noted that should a fluorescent bulb be deployed, then it may need a ballast, and starter if required. Nonetheless, the LED used herein, is similar to an LED used/deployed in Christmas lighting in size, shape, and configuration. Moreover, one can recall, that in years past, on a strand of Christmas lights, if one bulb went out, the whole strand of lights went out, which required using a good bulb, and swapping out one by one, the whole strand, which was not as bad as if one had a plurality of bulbs that went out simultaneously. Eventually, these types of lights were modified to have a shunt such that if the lighting portion of the LED burned out, that the shunt would work as a by pass to permit the remaining lights to light, which is the type of lamp system, and LED that is deployed here in this present invention, such as manufactured by Philips, GE, or other brand, although the color of the lighting should be a color of a typical bug attraction colors commonly known and used in the industry, although any color may be used.

The electrocution circuit means 50, comprises a voltage multiplying means having a voltage multiplier circuit 52, connected in series with a plurality of conductive wires 52A, 52B. In this particular embodiment, the respective values for the components are as follows: R1 & R2=25K resistor; R3 & R4=10 M resistor; C1 to C4=0.5 uF, 400V; D1 to D4=1 N4007 diode which circuit wise, is a voltage quadrupler, however, it is envisioned that a voltage double, tripler, or any multiplier would work as well, wherein R1 & R2 provide current limiting when the strike occurs, or should someone come in contact with the electrocution circuit via the mesh means 54, 64. Depending on the size of the desired profile(s) of the bug(s), larger capacitors may be deployed.

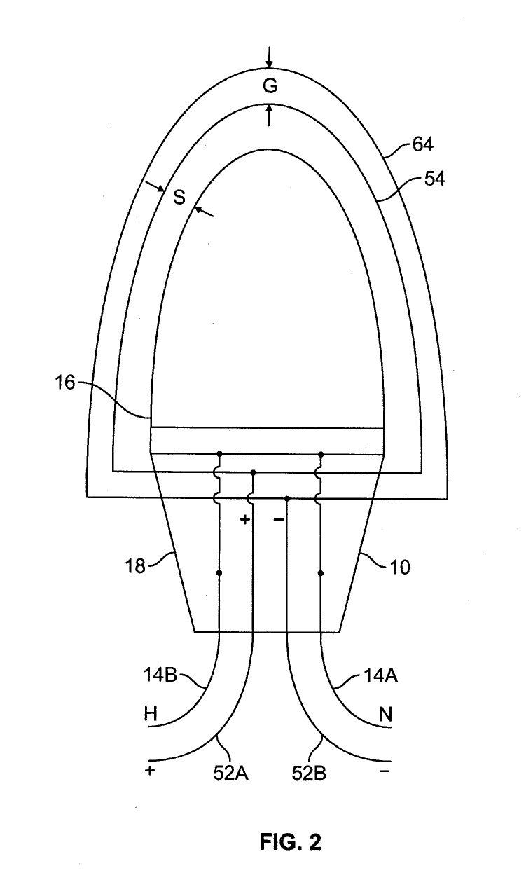

The conductive wires 52A connecting a plurality of inner mesh means 54 in series; and said conductive wires 52B connecting a plurality of outer mesh means 64 in series. See FIG. 2. The inner mesh means 54 substantially engulfs a light 16, while defining a space S between the inner surface of the mesh means 54, and the outer surface of the light 16; and wherein said outer mesh means 64 substantially engulfs both the light 16, and the inner mesh means 54 while defining a gap G between the two mesh means 54,64; wherein the inner mesh means 54 is connected to the positive terminal PT of said multiplying circuit 52, and the outer mesh means 64 is connected to the negative terminal NT of said multiplying circuit 52. It should be noted that the material selected for any of the mesh means needs to have the characteristic of being electrically conductive because the bridging of the gap G by the bug is what deploys the charge and to incapacitate and terminate the bug.

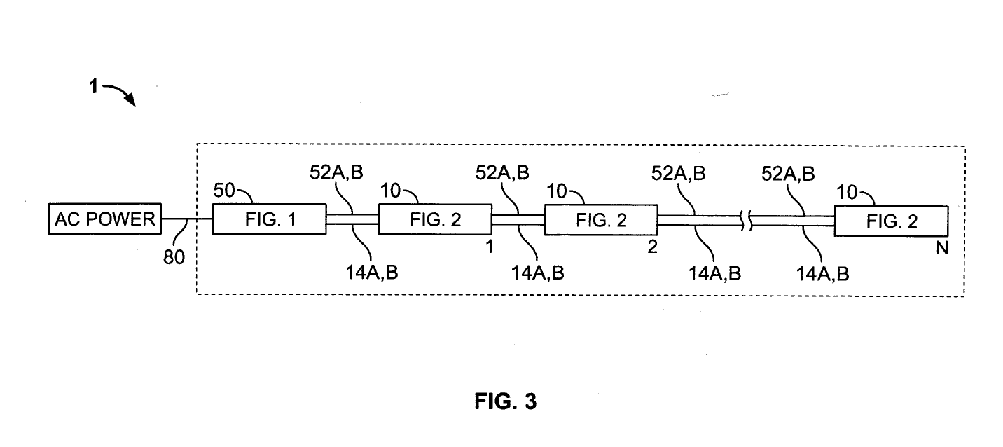

It is envisioned and intended that a plurality of systems 1 maybe connected together for longer lengths, such that, a connecting means can be incorporated on each end of the system so that they may be daisy chained together. For example, a plurality of 50 light count systems can be connected together end to end to for runs of 100, 150, etc. to the desired length. FIG. 3 illustrates a plurality of lighting means (illustrated in FIG. 2) connected together, e.g., FIG. 2₁, FIG. 2₂ . . . FIG. 2_{N}, units. N is envisioned to be from 2 to about 1,000 units, preferably 2 to about 100 units, although N may be any number but depends on the voltage drop across the lighting means and the number of means deployed. Moreover, a full wave bridge rectifier may be employed to maintain sufficient voltage to keep the lighting means on (not shown).

In an alternative embodiment, the string bug light termination system 101 includes a lighting means 110, an electrocution means 150, and a connecting means 180; wherein said connecting means 180 for connecting said lighting means 110, and electrocution means 150 to a power source in parallel.

The lighting means 110 includes a plurality of light assemblies 112 connected together in series by a plurality of conductive wires 114A, 114B. The electrocution circuit means 150 for terminating bugs connected in parallel to said lighting means 110, comprising a voltage multiplying means comprising a plurality of voltage multiplier circuits 152 connected in series with a plurality of conductive wires 152A, 152B; said conductive wires 152A connecting a plurality of inner mesh means 154 in series; and said conductive wires 152B connecting a plurality of outer mesh means 164 in series; wherein each light assembly 112 has a voltage multiplier circuit 152 dedicated thereto.

Each light assembly 112 includes a light 116, and a base 118 for receiving said light 116, for providing means to connect to the conductive wires 114A, 114B, and providing means for the inner and outer mesh means 154, 164 to connect to the conductive wires 152A, 152B, and providing means for housing 130 the multiplier 152. The type of light 116 may be either a light emitting diode, an incandescent bulb, or a fluorescent bulb, wherein an LED is shown in the figures. It should be noted that should a fluorescent bulb be deployed, then it may need a ballast, and starter if required. Nonetheless, the LED used herein, is similar to an LED used/deployed in Christmas lighting in size, shape, and configuration. Moreover; one can recall, that in years past, on a strand of Christmas lights, if one bulb went out, the whole strand of lights went out, which required using a good bulb, and swapping out one by one, the whole strand, which was not as bad as if one had a plurality of bulbs that went out simultaneously. Eventually, these types of lights were modified to have a shunt such that if the lighting portion of the LED burned out, that the shunt would work as a by pass to permit the remaining lights to light, which is the type of lamp system, and LED that is deployed here in this present invention, such as manufactured by Philips, GE, or other brand, although the color of the lighting should be a color of a typical bug attraction colors commonly known and used in the industry, although any color may be used.

In this particular embodiment, the respective values for the components are as follows: R1 & R2=25K resistor; R3 & R4=10 M resistor; C1 to C4=0.5 uF, 400V; D1 to D4=1 N4007 diode which circuit wise, is a voltage quadrupler, however, it is envisioned that a voltage double, tripler, or any multiplier would work as well, wherein R1 & R2 provide current limiting when the strike occurs, or should someone come in contact with the electrocution circuit via the mesh means 154, 164. Depending on the size of the desired profile(s) of the bug(s), larger capacitors may be deployed.

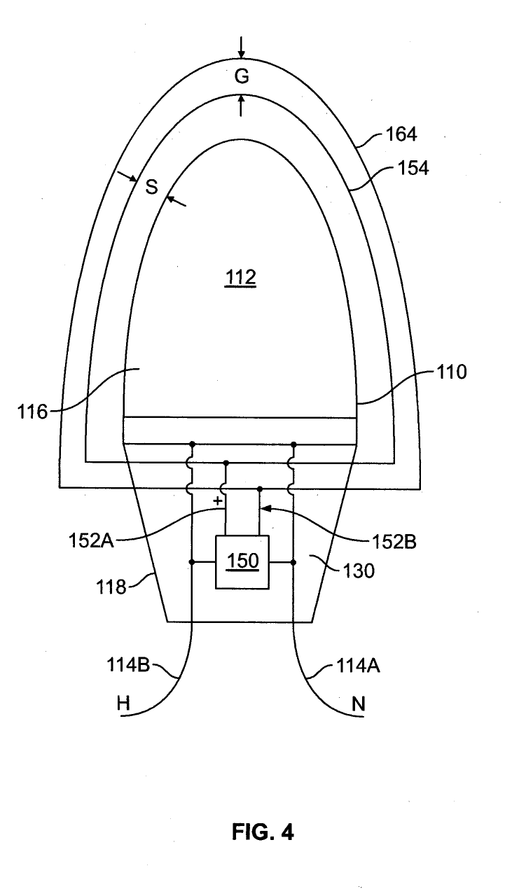

The conductive wires 152A connecting a plurality of inner mesh means 154 in series; and said conductive wires 152B connecting a plurality of outer mesh means 164 in series. See FIG. 4. The inner mesh means 154 substantially engulfs a light 116, while defining a space S between the inner surface of the mesh means 154, and the outer surface of the light 116; and wherein said outer mesh means 164 substantially engulfs both the light 116, and the inner mesh means 154 while defining a gap G between the two mesh means 154, 164; wherein the inner mesh means 154 is connected to the positive terminal PT of said multiplying circuit 152, and the outer mesh means 164 is connected to the negative terminal NT of said multiplying circuit 152. It should be noted that the material selected for any of the mesh means needs to have the characteristic of being electrically conductive because the bridging of the gap G by the bug is what deploys the charge and to incapacitate and terminate the bug.

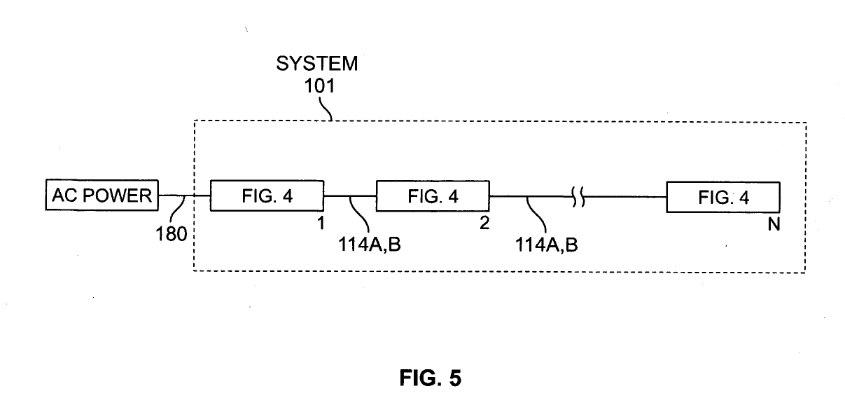

It is envisioned and intended that a plurality of systems 101 maybe connected together for longer lengths, such that, a connecting means can be incorporated on each end of the system so that they may be daisy chained together. For example, a plurality of 50 light count systems can be connected together end to end to for runs of 100, 150, etc. to the desired length. FIG. 5 illustrates a plurality of lighting means (illustrated in FIG. 4) connected together, e.g., FIG. 4₁, FIG. 4₂ . . . FIG. 4_{N}, units. N is envisioned to be from 2 to about 1,000 units, preferably 2 to about 100 units, although N may be any number but depends on the voltage drop across the lighting means and the number of means deployed. Moreover, a full wave bridge rectifier may be employed to maintain sufficient voltage to keep the lighting means on (not shown).

Although not required, in each of the above systems 1, and 101, it is envisioned the circuits can be improved to include full wave bridge rectifier having a smoothing capacitor so as to maintain the necessary voltage to maximize the time the lighting means 10, 110 and lamp are on.

All of the above referenced patents; patent applications and publications are hereby incorporated by reference. Many variations of the present invention will suggest themselves to those of ordinary skill in the art in light of the above detailed description. All such obvious modifications are within the full-intended spirit and scope of the claims of the present application.

What is claimed is:

1. A string bug light termination system comprising: a lighting means, an electrocution means, and a connecting means;
said connecting means for connecting said lighting means, and electrocution means system to a power source in parallel;
said lighting means comprising: a plurality of light assemblies connected together in series by a plurality of conductive wires (black/white/ground); and
said electrocution circuit means, comprising:
a voltage multiplying means comprising a voltage multiplier circuit connected in series with a plurality of conductive wires (black/white/ground); said conductive wires (red) connecting a plurality of inner mesh means in series; and said conductive wires (black) connecting a plurality of outer mesh means in series.

2. A system as in claim 1, wherein each light assembly includes a light, and a base for receiving said light, for providing means to connect to the conductive wires, and providing means for the inner and outer mesh means to connect to the conductive wires.

3. A system as in claim 2, wherein said light is selected from the group consisting of: a light emitting diode, an incandescent bulb, and a fluorescent bulb.

4. A system as in claim 1, wherein said inner mesh means substantially engulfs a light, while defining a space between the inner surface of the mesh means, and the outer surface of the light; and wherein said outer mesh means substantially engulfs both the light, and the inner mesh means while defining a gap between the two mesh means; wherein the inner mesh means is connected to the positive terminal of said multiplying circuit, and the outer mesh means is connected to the negative terminal of said multiplying circuit.

5. A bug light termination system comprising: a lighting means, an electrocution means, and a connecting means;
said connecting means for connecting said lighting means, and electrocution means to a power source in parallel;
said lighting means comprising: a plurality of light assemblies connected together in series by a plurality of conductive wires (black/white/ground); and
said electrocution circuit means for terminating bugs connected in parallel to said lighting means, comprising:
a voltage multiplying means comprising a plurality of voltage multiplier circuits connected in series with a plurality of conductive wires (black/white/ground); said conductive wires (black) connecting a plurality of inner mesh means in series; and said conductive wires (white) connecting a plurality of outer mesh means in series; wherein each light assembly has a voltage multiplier circuit dedicated thereto.

6. A system as in claim 5, wherein each light assembly includes a light, and a base for housing said light, for providing means to connect to the conductive wires, providing means for the inner and outer mesh means to connect to the conductive wires, and providing means for housing said multiplying circuit.

7. A system as in claim 6, wherein said light is selected from the group consisting of: a light emitting diode, an incandescent bulb, and a fluorescent bulb.

8. A system as in claim 5, wherein said inner mesh means substantially engulfs a light, while defining a space between the inner surface of the inner mesh means, and the outer surface of the light; and wherein said outer mesh means substantially engulfs both the light, and the inner mesh means while defining a gap between the two mesh means; wherein the inner mesh means is connected to the positive terminal of said voltage multiplying circuit, and the outer mesh means is connected to the negative terminal of said voltage multiplying circuit.
